(19) United States
(12) Patent Application Publication
(10) Pub. No.: US 2025/0155723 A1
(43) Pub. Date: May 15, 2025

(54) TEMPLE CONNECTING STRUCTURE AND HEAD-MOUNTED DISPLAY DEVICE

(71) Applicant: GOERTEK TECHNOLOGY CO., LTD, Qingdao, Shandong (CN)

(72) Inventor: Chuanlong LI, Qingdao, Shandong (CN)

(21) Appl. No.: 18/834,310

(22) PCT Filed: Mar. 15, 2023
(86) PCT No.: PCT/CN2023/081590

§ 371 Date: Jul. 30, 2024

(30) Foreign Application Priority Data
Mar. 16, 2022 (CN) 202210261477.X

(51) Int. Cl. G02B 27/01; G02C 5/22

(52) U.S. Cl. CPC G02B 27/0176; G02C 5/2227

(57) ABSTRACT

Disclosed are a temple connecting structure and a head-mounted display device. The head-mounted display device comprises a glass frame (71) and two temples (73) respectively provided at two ends of the glass frame (71). The temple connecting structure comprises: a base (10); mounting brackets (20) rotatably connected to the base (10), wherein two mounting brackets (20) are provided, one of the mounting brackets (20) is connected to the glass frame (71), and the other of the mounting brackets (20) is connected to the temples (73); and clamping elastic members (30) provided corresponding to each of the mounting brackets (20) and connected between the respective mounting brackets (20) and the base (10). The temple connecting structure can improve the wearing stability of the temples (73), thereby avoiding the problem of accidental falling off of the head-mounted display device.

The present application claims the priority to the Chinese Patent Application No. 202210261477.X, entitled “TEMPLE CONNECTING STRUCTURE AND HEAD-MOUNTED DISPLAY DEVICE” filed with China Patent Office on Mar. 16, 2022, the entire contents of which are incorporated into the present application by reference.

### TECHNICAL FIELD

The present disclosure relates to a technical field of head-mounted display device, and more particularly, to a temple connecting structure and a head-mounted display device.

### DESCRIPTION OF RELATED ART

Current head-mounted display devices, such as but not limited to AR (Augmented Reality) glasses, VR (Virtual Reality) glasses, and MR (Mixed Reality) glasses, generally use a simple hinge structure as the connecting structure between the temples and the glass frame. For users with smaller head sizes, the temples cannot fit well on the ears, resulting in slipping off of one temple or even accidental falling off of the device.

### SUMMARY

A main purpose of the present disclosure is to provide s temple connecting structure, aiming at improving the wearing stability of the temples, thereby avoiding the problem of accidental falling off of the head-mounted display device.

In order to achieve the above purpose, the present disclosure provides a temple connecting structure applied to a head-mounted display device including a glass frame and two temples respectively provided at two ends of the glass frame, the temple connecting structure includes: a base; mounting brackets rotatably connected to the base, wherein two mounting brackets are provided, one of the mounting brackets is connected to the glass frame, and the other of the mounting brackets is connected to the temples; and clamping elastic members provided corresponding to each of the mounting brackets and connected between the respective mounting brackets and the base.

Optionally, the clamping elastic member is configured as a torsion spring, which has a columnar spiral portion and two mounting portions respectively provided at two ends of the spiral portion, wherein one of the mounting portions is connected to the base, and the other of the mounting portions is connected to the mounting bracket, and a gap is formed between two adjacent turns of the spiral portion. One of the base and the mounting brackets is provided with a mounting column, the torsion spring is sleeved on the mounting column, and one end of the mounting column that passes through the torsion spring is provided with a first threaded portion. The temple connecting structure further includes a first fastener, which is threadedly connected to the first threaded portion and abuts against the spiral portion of the torsion spring.

Optionally, the mounting bracket is provided with a first limiting groove at a position corresponding to the torsion spring, the first limiting groove extends along a circumference direction of the mounting column and has a first end wall and a second end wall opposite to each other, and the mounting portion of the torsion spring slides in the first limiting groove. The mounting bracket has a plurality of rotation positions including a folding position, an adaptation position and an eversion position in sequential, the mounting portion is separated from the first end wall at between the folding position and the adaptation position, the mounting portion abuts against the first end wall at the eversion position, and the torsion spring generates an elastic force, so that the mounting bracket has a tendency to rotate toward the adaptation position.

Optionally, at the adaptation position, an angle between the two mounting brackets is an obtuse angle and the two temples are positioned close to each other.

Optionally, the temple connecting structure further includes a damping member mounted on the base and configured to generate a damping effect on a rotation of the mounting bracket relative to the base.

Optionally, one of the base and the mounting bracket is provided with an axle hole, the other of the base and the mounting bracket is supported against a hole edge of the axle hole and is provided with a rotating shaft corresponding to the axle hole, the rotating shaft is rotatably connected to the axle hole, and the damping member is configured to make the mounting bracket and the base have a tendency to push against each other.

Optionally, the damping member has elasticity and an annular shape, the rotating shaft is provided with a second threaded portion, the second threaded portion passes through the axle hole and the damping member and is threadedly connected to a second fastener, and the damping member is interposed between the second fastener and the other hole edge of the axle hole.

Optionally, the damping element is a disc spring.

Optionally, the base is provided with two first rotating portions, axes of the two first rotating portions are parallel and spaced apart from each other, one of the first rotating portions is rotatably connected to one of the mounting brackets, and the other of the first rotating portions is rotatably connected to the other of the mounting brackets.

Optionally, the first rotating portion is an axle hole, the mounting bracket is provided with a rotating shaft corresponding to the axle hole, and a transmission structure is further provided between the rotating shafts on the two mounting brackets, wherein the transmission structure is configured to transmit the rotational motions of the two mounting brackets to each other.

Optionally, the transmission structure includes a first tooth portion and a second tooth portion meshing with each other, the first tooth portion is provided on a periphery of one of the rotating shafts, and the second tooth portion is provided on a periphery of the other of the rotating shafts.

Optionally, the head-mounted display device further includes a functional part including at least one of a wiring harness, a flexible printed circuit board and a flexible thermal conductor. A first chamber is provided in the glass frame, a second chamber is provided in the temple, and the first chamber is in communication with the second chamber through which the functional part passes. An avoidance gap is formed between a chamber opening of the first chamber and a chamber opening of the second chamber, and the avoidance gap is located between the two mounting brackets. The temple connecting structure further includes a blocking cover disposed on the avoidance gap.

Optionally, the avoidance gap includes a first gap located at an outer side of the temple and a second gap located at an inner side of the temple, the blocking cover includes an outer blocking cover disposed on the first gap and an inner blocking cover disposed on the second gap, and the inner blocking cover is disposed opposite to the outer blocking cover.

Optionally, the inner blocking cover is fixed to the base by a screw, and the outer blocking cover is snapped and installed on the inner blocking cover.

Optionally, each of the two opposite side edges of the inner blocking cover has a first cylindrical surface, wherein the temple slides and abuts against one of the first cylindrical surfaces, and the glass frame slides and abuts against the other of the first cylindrical surfaces.

Optionally, each of the two opposite side edges of the inner blocking cover is provided with a first notch through which the functional part passes.

Optionally, each of the two opposite side edges of the outer blocking cover has a second cylindrical surface, wherein the temple slides and abuts against one of the second cylindrical surfaces, and the glass frame slides and abuts against the other of the second cylindrical surfaces.

Optionally, each of the two opposite side edges of the outer blocking cover is provided with a second notch through which the functional part passes.

The present disclosure also provides a head-mounted display device, including temples, a glass frame, and a temple connecting structure described above, one of the mounting brackets of the temple connecting structure is connected to the temples, and the other of the mounting brackets is connected to the glass frame.

In the technical solution of the present disclosure, a clamping force is applied to the mounting brackets by using a clamping elastic members, the clamping force can make the glass frame and the temples on the two mounting brackets tend to move closer to each other within a certain position range, so that the temples can be more close-fittingly worn on the ears through the clamping effect of the two temples when being worn, thereby improving the stability and reliability of wearing the temples, making the device less likely to fall off ears of the user. Furthermore, enable the device to adapt to different user head sizes, thereby improving user experience and enhancing the market competitiveness of the device.

### BRIEF DESCRIPTION OF DRAWINGS

In order to more clearly illustrate the embodiments of the present disclosure or the technical solutions in the prior art, the drawings required to be used for the content of the embodiments or the prior art will be briefly introduced in the following. Obviously, the drawings in the following description are merely a part of the drawings of the present disclosure, and for those of ordinary skill in the art, other drawings can also be obtained from the provided drawings without any creative effort.

FIG. 1 is an exploded schematic diagram of parts of a head-mounted display device according to an embodiment of the present disclosure.

FIG. 2 is a schematic structural diagram of a temple connecting structure in FIG. 1.

FIG. 3 is an exploded schematic diagram of parts of the temple connecting structure in FIG. 2.

FIG. 4 is a rear view of the temple connecting structure in FIG. 2.

FIG. 5 is a front view of the temple connecting structure in FIG. 2.

FIG. 6 is a schematic structural diagram of clamping elastic members in FIG. 2.

FIG. 7 is a schematic structural diagram of a base in FIG. 3.

FIG. 8 is another schematic structural diagram of the base in FIG. 3.

FIG. 9 is a schematic structural diagram of mounting brackets in FIG. 3.

FIG. 10 is another schematic structural diagram of the mounting brackets in FIG. 3.

FIG. 11 is a schematic diagram showing the mounting brackets in FIG. 3 is at a folding position.

FIG. 12 is a schematic diagram showing the mounting brackets in FIG. 3 at an adaptation position.

FIG. 13 is a schematic diagram showing the mounting brackets in FIG. 3 at an eversion position.

FIG. 14 is a schematic structural diagram of a base, mounting brackets and a blocking cover in FIG. 1.

FIG. 15 is another schematic structural diagram of the base, mounting brackets and the blocking cover in FIG. 1.

FIG. 16 is a cross-sectional view of the head-mounted display device in FIG. 1.

FIG. 17 is another cross-sectional view of the head-mounted display device in FIG. 1.

FIG. 18 is a schematic structural diagram showing the temples of the head-mounted display device in FIG. 1 in a folded state.

FIG. 19 is another schematic structural diagram showing the temples of the head-mounted display device in FIG. 1 in a folded state.

FIG. 20 is a schematic structural diagram showing the temples of the head-mounted display device in FIG. 1 in a wearing state.

### EXPLANATION OF REFERENCE NUMERALS

| Numeral | Name | Numeral | Name |
|---|---|---|---|
| 10 | Base | 31 | Spiral portion |
| 11 | Substrate | 32 | Mounting portion |
| 111 | Axle hole | 41 | First fastener |
| 112 | Limiting protrusion | 42 | Second fastener |
| 12 | Mounting plate | 51 | Damping member |
| 121 | Socket | 52 | First washer |
| 122 | Screw hole | 53 | Second washer |
| 123 | Limiting hole | 60 | Functional parts |
| 20 | Mounting bracket | 61 | Flexible printed circuit |
| | | | board |
| 21 | Body section | 62 | Flexible thermal |
| | | | conductor |
| 22 | Mounting section | 71 | Glass frame |
| 221 | Positioning hole | 72 | First chamber |
| 222 | Screw hole | 73 | Temples |
| 23 | Step section | 74 | Second chamber |
| 24 | Mounting column | 75 | Avoidance gap |
| 241 | First threaded portion | 751 | First gap |
| 25 | First limiting groove | 752 | Second gap |
| 251 | First end wall | 80 | Blocking cover |
| 252 | Second end wall | 81 | Outer blocking cover |
| 26 | Rotating shaft | 811 | Second cylindrical |
| | | | surface |
| 261 | Second threaded | 812 | Second notch |
| | portion | | |
| 27 | Transmission structure | 82 | Inner blocking cover |
| 271 | First tooth portion | 821 | First cylindrical |
| | | | surface |
| 272 | Second tooth portion | 822 | First notch |
| 28 | Second limiting | 823 | Avoidance hole |
| | groove | | |
| 30 | Clamping elastic member | | |

The realization of the purpose, functional features and advantages of the present disclosure will be further explained in conjunction with embodiments and with reference to the accompanying drawings.

### DETAILED DESCRIPTIONS

Technical solutions of embodiments of the present disclosure will be described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

It should be noted that if the embodiments of the present disclosure involve directional indications (such as up, down, left, right, front, back . . . ), the directional indications are only used to explain the relative position relationship, movement status, etc. between the components under a certain specific posture (as shown in the drawings), and if the specific posture changes, the directional indications will also change accordingly.

Current head-mounted display devices, such as but not limited to AR (Augmented Reality) glasses, VR (Virtual Reality) glasses, and MR (Mixed Reality) glasses, generally use a simple hinged structure as the connecting structure between the temples and the glass frame. For users with smaller head sizes, the temples cannot fit well on the ears, resulting in slipping off of one temple or even accidental falling off of the device.

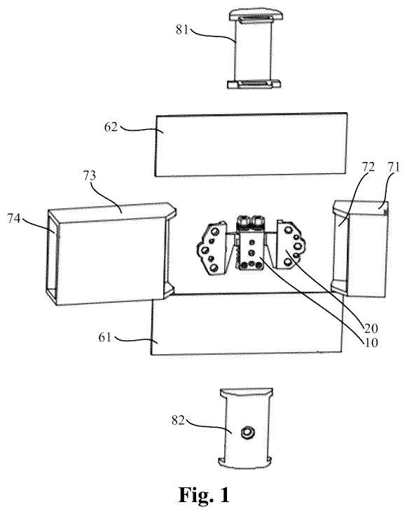

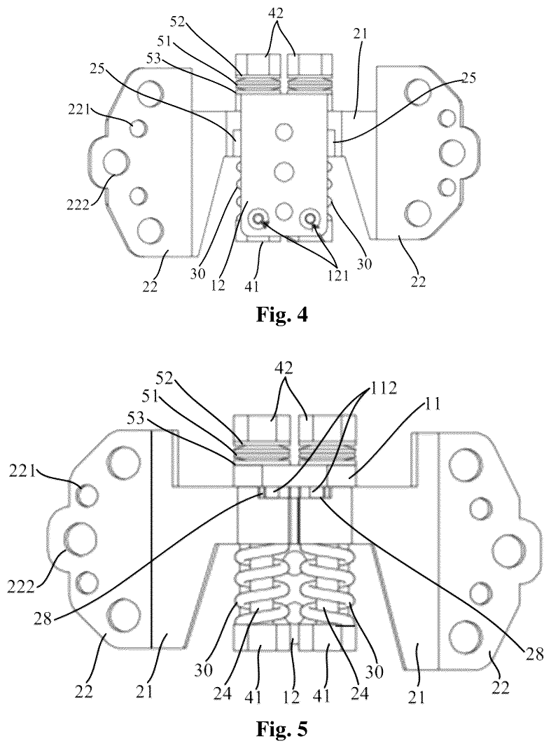

In view of this, the present disclosure proposes a temple connecting structure for a head-mounted display device, the head-mounted display device including a glass frame and two temples respectively provided at two ends of the glass frame. Referring to FIGS. 1 to 5, in an embodiment of the present disclosure, the temple connecting structure includes:

a base 10;

mounting brackets 20 rotatably connected to the base 10, wherein two mounting brackets 20 are provided, one of the mounting brackets 20 is connected to the glass frame 71, and the other of the mounting brackets 20 is connected to the temples 73; and

clamping elastic members 30 provided corresponding to each of the mounting brackets 20 and connected between the respective mounting brackets 20 and the base 10.

In the technical solution of the present disclosure, a clamping force is applied to the mounting brackets 20 by using a clamping elastic members 30, the clamping force can make the glass frame 71 and the temples 73 on the two mounting brackets 20 tend to move closer to each other within a certain position range, so that the temples 73 can be more close-fittingly worn on the ears through the clamping effect of the two temples 73 when being worn, thereby improving the stability and reliability of wearing the temples 73, making the device less likely to fall off the ears of the user. Furthermore, enable the device to adapt to different user head sizes, thereby improving user experience and enhancing the market competitiveness of the device. Specifically, assuming that an angle between the temple 73 being in a folded state and the glass frame 71 is 0°, and assuming that in order to meet the wearing requirements of different head sizes, the temple 73 is set to have an angle ranges from 80° to 100° with the glass frame 71 when it is unfolded to a wearing state, the clamping elastic members 30 may be configured to generate a clamping force after an angle between the temples 73 is greater than or equal to 70°. It will be understood that, for users with smaller head sizes, corresponding wearing angle of the temple 73 is 80°, and the clamping force generated by the clamping elastic member 30 may also be smaller; and for users with larger head sizes, corresponding wearing angle of the temple 73 is 100°, and the clamping force generated by the clamping elastic member 30 may also be larger. Therefore, the technical solution of the present disclosure can adapt to head sizes within a certain range and provide a clamping force of the temples 73 for this group of users when they wear the device, so that the temples 73 on both sides are not easy to slip off the ears, and the device can be prevented from falling off. Of course, in other embodiments, the angle may be set to other values, for example, the clamping force may be generated when the angle is greater than or equal to 20° (or 45°, or) 90°.

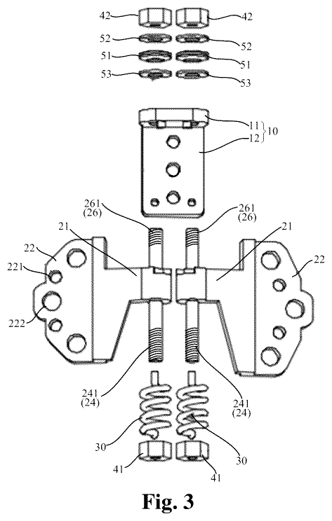

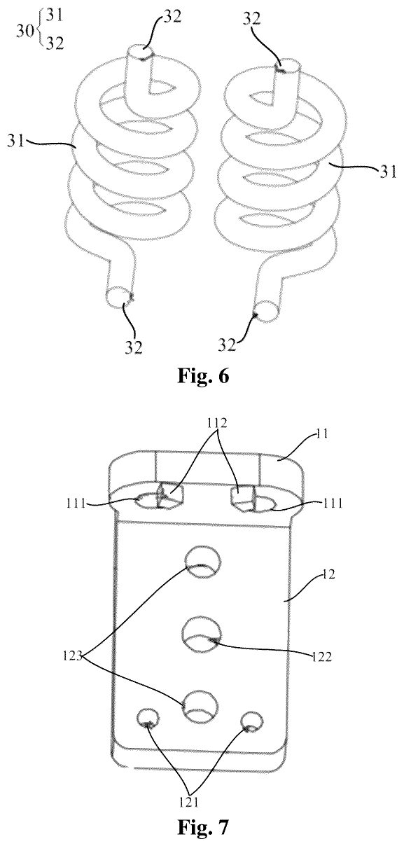

Referring to FIGS. 3, 5 and 6, in the embodiment, optionally, the clamping elastic member 30 is configured as a torsion spring. The torsion spring have the advantages of simple structure, stable operation and long service life, which is beneficial to reducing the manufacturing cost of the device and reducing the failure rate of the device. Of course, in other embodiments, the clamping elastic member may also be a clockwork spring, a Japanese spring clip or a U-shaped sheet spring, etc.

Further, in the present embodiment, the torsion spring has a columnar spiral portion 31 and two mounting portions 32 respectively provided at two ends of the spiral portion 31, wherein one of the mounting portions 32 is connected to the base 10, and the other of the mounting portions 32 is connected to the mounting bracket 20, and a gap is formed between two adjacent turns of the spiral portion 31. The mounting bracket 20 is protrusively provided with a mounting column 24, the torsion spring is sleeved on the mounting column 24, and one end of the mounting column 24 that passes through the torsion spring is provided with a first threaded portion 241. The temple 73 connecting structure further includes a first fastener 41, which is threadedly connected to the first threaded portion 241 and abuts against the spiral portion 31 of the torsion spring. Specifically, in the present embodiment, the first threaded portion 241 is an external threaded column, and the first fastener 41 is correspondingly configured as a nut. Of course, in other embodiments, the first threaded portion may be a threaded hole, and the first fastener may be correspondingly configured as a bolt, and a nut of the bolt may be supported against the spiral portion of the torsion spring. Specifically, in the embodiment, the torsion spring is a cylindrical helical torsion spring, and is set in a non-dense body, that is, there is a gap between two adjacent coils (steel wires) of the torsion spring, so that an axial length of the torsion spring can be adjusted (compressed). In the embodiment, the gap between two adjacent turns of the torsion spring is adjusted (compressed) by adjusting the amount of screwing of the nut on the mounting column 24, thereby adjusting the axial length of the torsion spring, and further adjusting the actual working torque of the torsion spring to meet the design requirements, making the rotational operating force of the temples 73 of different products in mass production tend to be consistent, that is, improving the quality consistency of the products and enhancing the market competitiveness. It will be understood that the mounting column 24 mainly serves to adjust the axial length of the torsion spring in cooperation with the first fastener 41, so no matter whether the mounting column 24 is provided on the mounting bracket 20 or the base 10, the above-mentioned function can be achieved, and it is not specifically limited to it.

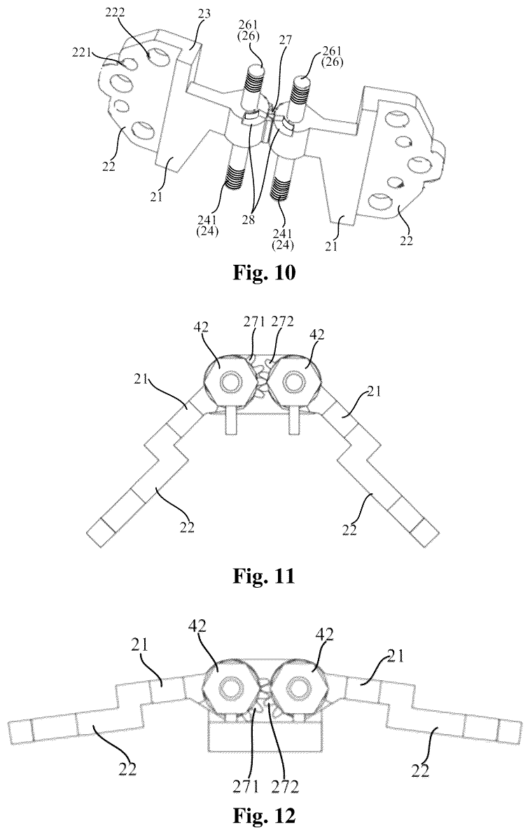

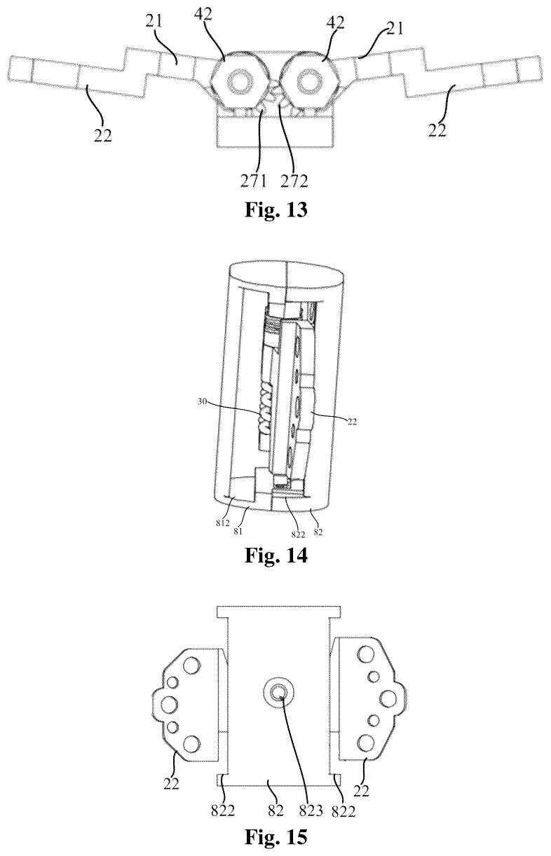

Furthermore, referring to FIGS. 1, 4, 6 and 9, in the embodiment, the mounting bracket 20 is provided with a first limiting groove 25 at a position corresponding to the torsion spring. The first limiting groove 25 extends along a circumference direction of the mounting column 24 and has a first end wall 251 and a second end wall 252 opposite to each other, and the mounting portion 32 of the torsion spring slides in the first limiting groove 25. The mounting bracket 20 has a plurality of rotation positions including a folding position, an adaptation position and an eversion position in sequential. The mounting portion 32 is separated from the first end wall 251 at between the folding position and the adaptation position. The mounting portion 32 abuts against the first end wall 251 at the eversion position, and the torsion spring generates an elastic force, so that the mounting bracket 20 has a tendency to rotate toward the adaptation position. Specifically, referring to FIGS. 11 to 13 together, FIG. 11 shows that the two mounting brackets 20 are at the folding position, FIG. 12 shows that the two mounting brackets 20 are at the adaptation position, and FIG. 13 shows that the two mounting brackets 20 are at the eversion position, it can be seen that an angle between the two mounting brackets 20 in FIG. 12 is an obtuse angle, and the angle between the two mounting brackets 20 in FIG. 13 exceeds 180°. In addition, at the folding position, the mounting portion 32 may or may not abut against the second end wall 252. It should be noted that the folding position of the mounting bracket 20 corresponds to the folded state of the temple 73, and a rotation range between the adaptation position and the eversion position corresponds to the wearing state of the temple 73. In this way, it can be ensured that the temples 73 will generate a clamping force when being worn. And, since the mounting bracket 20 rotates between the folding position and the adaptation position, the torsion spring does not generate an elastic force, so the temple 73 can be easily rotated, which is convenient for the user to unfold and wear the temples 73 and may not cause excessive clamping force after wearing, thereby improving wearing comfort. Of course, in other embodiments, the mounting bracket may not be provided with the first limiting groove, but may be provided with a socket into which the mounting portion of the torsion spring is inserted.

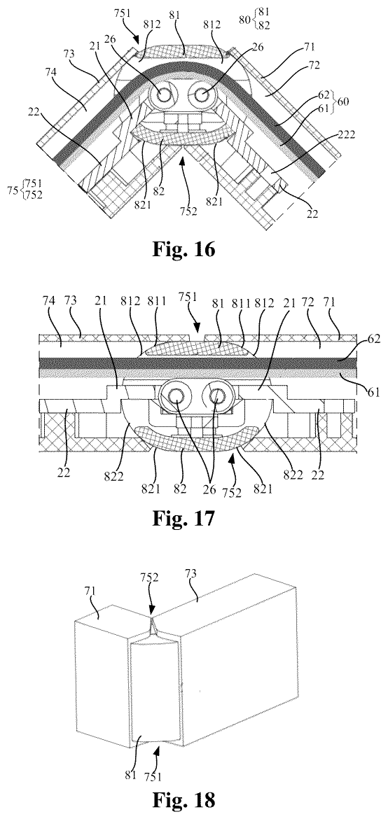

It should be noted that, in the embodiment, the two mounting brackets 20 are respectively mounted on the temples 73 and the glass frame 71. Referring to FIGS. 16 and 17, FIG. 16 shows a state where the angle between the two mounting brackets in the temple connecting structure is 90°, and FIG. 17 shows a state where the angle between the two mounting brackets is 180°. An angle between the mounting bracket 20 mounted on the glass frame 71 and the glass frame 71 is 90° or close to 90°, and an angle between the mounting bracket 20 mounted on the temple 73 and the temple 73 is 0° or close to 0°. As such, when the temple 73 is in a folded state, that is, the angle between the temple 73 and the glass frame 71 is 0° or close to 0°, and the angle between the two mounting brackets 20 is 90°. When the temple 73 is rotated to a position having an angle of 90° with the glass frame 71, the angle between the two mounting brackets 20 is 180°. Therefore, in the embodiment where the torsion spring is configured to generate a clamping force after the angle between the temples 73 is greater than or equal to 70°, the angle between the two mounting brackets 20 corresponds to 160°. It will be understood that in this state, the two temples 73 at both ends of the glass frame 71 are positioned close to each other. Of course, the angle between the two mounting brackets 20 may also be 170° or 140°, that is, any obtuse angle between 120° and 180° is acceptable. Specifically, referring to FIGS. 11 to 13 together, FIG. 11 shows that the two mounting brackets 20 are at the folding position, FIG. 12 shows that the two mounting brackets 20 are at the adaptation position, and FIG. 13 shows that the two mounting brackets 20 are at the eversion position, it can be seen that an angle between the two mounting brackets 20 in FIG. 12 is an obtuse angle, and the angle between the two mounting brackets 20 in FIG. 13 exceeds 180°.

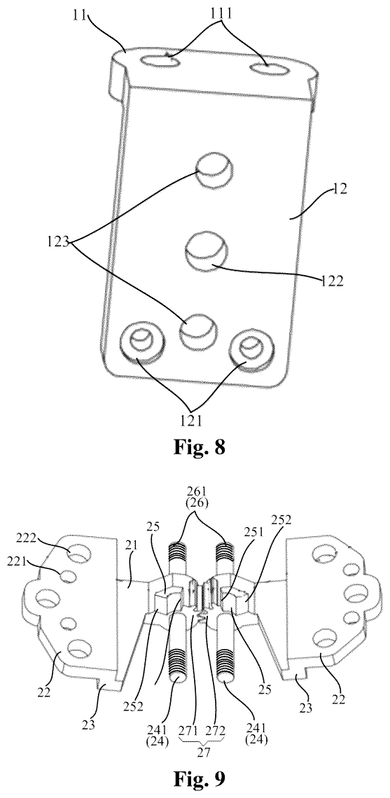

Furthermore, referring to FIGS. 7 to 9 and 16, in the embodiment, the mounting bracket 20 includes a body section 21 and a mounting section 22, the mounting section 22 is connected with the temple 73 or the glass frame 71, and the mounting column 24 and the first limiting groove 25 are both provided on the body section 21. The body section 21 is protrusively provided with a rotating shaft 26, and the rotating shaft 26 and the mounting column 24 are coaxial and arranged in opposite directions. The base 10 includes a substrate 11 and a mounting plate 12 which are arranged in an intersecting manner, the substrate 11 is provided with an axle hole 111, the rotating shaft 26 is rotatably connected to the axle hole 111, the mounting plate 12 is provided with a socket 121, one of the mounting portions 32 of the torsion spring slides in the first limiting groove 25, and the other of the mounting portions 32 is inserted into the socket 121. In this way, the operation of installing the mounting bracket 20 and the torsion spring onto the base 10 can be facilitated, thereby improving production efficiency. Of course, in other embodiments, the base may be protrusively provided with a rotating shaft, and an axle hole may be provided in the body section corresponding to the rotating shaft, and the torsion spring may be directly welded or bonded to a surface of the mounting plate.

In the embodiment, optionally, the mounting portion 32 of the torsion spring is fixed to the socket 121. As such, the installation reliability and working stability of the torsion spring can be improved. Of course, in other embodiments, the mounting portion of the torsion spring may be inserted into and bonded to the socket, or the mounting portion may pass through the socket, and the portion passing through the socket may be bent and abut against an edge of the socket.

Furthermore, referring to FIGS. 5, 7 and 10, in the embodiment, the body section 21 of the mounting bracket 20 is also provided with a second limiting groove 28, and the second limiting groove 28 extends along the circumference direction of the axle hole 111. The hole edge of the axle hole 111 is provided with a limiting protrusion 112 corresponding to the second limiting groove 28, and the limiting protrusion 112 slides in the second limiting groove 28. In this way, by matching the limiting protrusion 112 with the second limiting groove 28, two extreme positions, i.e. an extreme folded position and an extreme unfolded position, where the mounting bracket 20 rotates relative to the base 10 can be defined, thereby avoiding collision or interference between the edges of the temple 73 and the glass frame 71 during rotation, so as to protect the temple 73 and the glass frame 71.

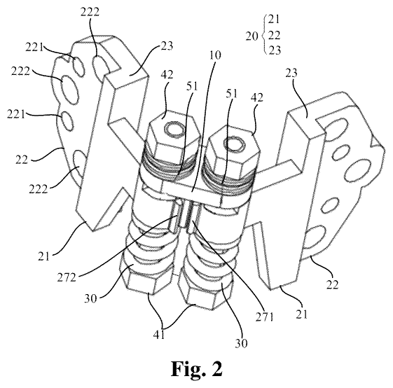

Referring to FIGS. 2 and 16, in the embodiment, optionally, the mounting section 22 is provided with a positioning hole 221 and a screw hole 222. The positioning hole 221 is used for inserting a positioning column on the temple 73 or the glass frame 71, and the screw hole 222 is configured to lock the screw onto the temple 73 or the glass frame 71. Of course, in other embodiments, the mounting section may be mounted on the temple or glass frame by means of snap connection, bonding, welding, or the like.

Referring to FIGS. 2, 9 and 10, in the embodiment, optionally, a step section 23 is connected between the mounting section 22 and the body section 21. As such, the structural strength of the mounting bracket 20 can be improved, and the mounting section 22 can be closer to an inner wall of the temple 73 (or the glass frame 71) than the body section 21, thereby reducing the height of the positioning column and the screw hole column protruding on the inner wall of the temple 73 or the glass frame 71, thereby improving the structural strength of the positioning column and the screw hole column, and thereby improving the connection strength between the mounting bracket 20 and the temple 73 (or the glass frame 71). Of course, in other embodiments, a step section may not be provided.

Furthermore, referring to FIGS. 2 to 4, in the embodiment, the temple 73 connecting structure includes a damping member 51 mounted on the base 10 and configured to generate a damping effect on the rotation of the mounting bracket 20 relative to the base 10. In this way, the temple 73 can have a damping effect on the rotation relative to the glass frame 71, thereby improving product quality and user experience, and enhancing product market competitiveness. Specifically, in the embodiment, the rotating shaft 26 on the mounting bracket 20 rotates in the axle hole 111 on the base 10, the axle hole 111 has two opposite hole edges, the body section 21 abuts against one hole edge of the axle hole 111, and the damping member 51 is configured to make the body section 21 and the hole edge of the axle hole 111 have a tendency to push against each other, thereby increasing the dynamic friction between the body section 21 and the hole edge of the axle hole 111, and thereby endowing the mounting bracket 20 (the temple 73) with a damping effect on rotating. Of course, in other embodiments, the damping member may also be configured as a gear damper structure, specifically, a first gear may be provided on the periphery of the rotating shaft, a second gear may be provided on the base corresponding to the first gear, the second gear is rotatably connected to the base, and the first gear engages with the second gear. In addition, it is also possible to consider coating damping silicone between the first gear and the second gear to further optimize the damping effect.

Referring to FIGS. 2 to 4, in the embodiment, optionally, the damping member 51 has elasticity and an annular shape, the rotating shaft 26 is provided with a second threaded portion 261, the second threaded portion 261 passes through the axle hole 111 and the damping member 51 and is threadedly connected to a second fastener 42, and the damping member 51 is interposed between the second fastener 42 and the other hole edge of the axle hole 111. Specifically, in the embodiment, the second threaded portion 261 is an external threaded column, and the second fastener 42 is correspondingly configured as a nut. In this way, by adjusting the amount of screwing of the nut on the external threaded column, the thickness of the damping member 51 in the axial direction of the rotating shaft 26 is adjusted, and thus the reaction force applied by the damping member 51 to the mounting bracket 20 and the base 10 can be adjusted, and the dynamic friction force when the mounting bracket 20 rotates relative to the base 10 can be adjusted, that is, the damping force is adjusted to meet design requirements. Meanwhile, it is possible to make the rotational damping force of the temples 73 of different products in mass production tend to be consistent, that is, improve the quality consistency of the products and enhance the market competitiveness. Of course, in other embodiments, the second threaded portion may be a threaded hole, the second fastener may be a bolt, the stud of the bolt may pass through the damping member and be connected to the threaded hole, and the damping member may be clamped between the nut of the bolt and the base.

In the embodiment, optionally, the damping member 51 is configured as a disc spring. Since the disc spring has the advantages of being wear-resistant and stable and reliable in operation, the damping force generated by the damping member 51 can be kept stable and the service life can be increased. Of course, in other embodiments, the damping element may be configured as a spring washer, or an elastic silicone body, an elastic rubber body, etc.

Referring to FIGS. 3 to 5, in the embodiment, optionally, the temple 73 connecting structure further includes a first washer 52 interposed between the disc spring and the nut, and a second washer 53 interposed between the disc spring and the substrate 11. As such, the disc spring is protected by the first washer 52 and the second washer 53, so that the disc spring is less prone to be worn, thereby ensuring its working stability and increasing its service life. Of course, in other embodiments, only the first gasket or only the second gasket may be provided.

Furthermore, referring to FIGS. 3, 7, 8 and 16, in the embodiment, the substrate 11 is provided with two axle holes 111, axes of the two axle holes 111 are parallel and spaced apart from each other, wherein one axle hole 111 is rotatably connected to one mounting bracket 20, and the other axle hole 111 is rotatably connected to the other mounting bracket 20. It should be noted that “parallel” means parallel or nearly parallel. In this way, through the structure of two axes of rotating shafts 26, that is, the axes of rotating shafts 26 corresponding to the two mounting brackets 20 have a certain interval, which can increase a bending radius of the temple 73 connecting structure, that is, when the functional parts 60 such as the wiring harness and the flexible printed circuit board 61 are bent following the temple 73 connecting structure, the radius of the functional parts 60 after being bent is larger, thereby facilitating the bending of the functional parts 60 here and preventing the functional parts 60 from significantly reducing performance or significantly shortening life due to bending. Of course, in other embodiments, the substrate may be provided with one axle hole, and the rotating shafts on the two mounting brackets are rotatably connected to the axle hole, or alternatively, two rotating shafts are provided on opposite sides of the substrate, the axes of the two rotating shafts are arranged colinearly, and the two mounting brackets are rotatably connected to the two rotating shafts respectively.

Furthermore, referring to FIGS. 2 and 9 to 13, in the embodiment, a transmission structure 27 is provided between the rotating shafts 26 on the two mounting brackets 20, the transmission structure 27 is configured to transmit the rotational motions of the two mounting brackets 20 to each other. In this way, transmission between the two mounting brackets 20 can be achieved through the transmission structure 27, so that the rotation angle originally completed by one mounting bracket 20 is completed by the two mounting brackets 20 rotating simultaneously. For example, assuming that the two mounting brackets 20 need to rotate from an angle of 90° to an angle of 180°, if only one mounting bracket 20 completes the rotation, the mounting bracket 20 needs to rotate 90° relative to the base 10, and in the embodiment, since the two mounting brackets 20 rotate simultaneously, each mounting bracket 20 only needs to rotate 45° relative to the base 10. As a result, the operation of folding and unfolding the temples 73 can be facilitated, thereby improving the user experience. Of course, in other embodiments, a transmission structure may not be provided.

Referring to FIGS. 9 to 13, in the embodiment, optionally, the transmission structure 27 includes a first tooth portion 271 and a second tooth portion 272 that mesh with each other. The first tooth portion 271 is provided on a periphery of one of the rotating shafts 26, and the second tooth portion 272 is provided on a periphery of the other of the rotating shafts 26. In this way, the gear meshing method can improve the smoothness and stability of the transmission between the two mounting brackets 20. Of course, in other embodiments, the transmission structure may also be configured as an elastic rubber sleeve, such as a rubber sleeve or a silicone sleeve, which is sleeved on the rotating shaft. Two elastic rubber sleeves achieve abutment and rolling through static friction, thereby realizing mutual transmission of the rotational motions of the two mounting brackets, or alternatively, the transmission structure is configured as a belt, the rotating shaft is provided with an installation groove corresponding to the belt, and the belt is embedded in the installation groove.

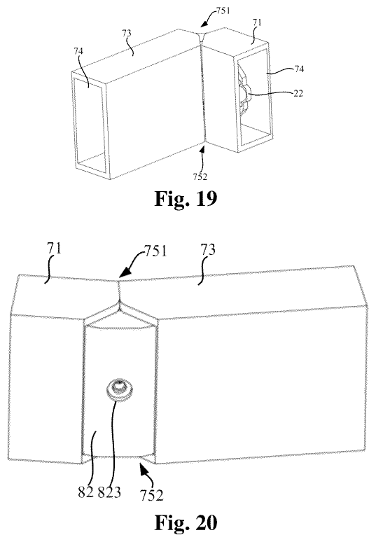

Furthermore, referring to FIGS. 1 and 16 to 20, in the embodiment, the head-mounted display device further includes functional parts 60 including at least one of a wiring harness (not shown in the drawings), a flexible printed circuit board 61 and a flexible thermal conductor 62. A first chamber 72 is provided in the glass frame 71, a second chamber 74 is provided in the temple 73, and the first chamber 72 is in communication with the second chamber 74 through which the functional parts 60 passes. An avoidance gap 75 is formed between a chamber opening of the first chamber 72 and a chamber opening of the second chamber 74, and the avoidance gap 75 is located between the two mounting brackets 20. The temple 73 connecting structure further includes a blocking cover 80 arranged in the avoidance gap 75. In this way, the functional parts 60 that may originally be exposed outside in the avoidance gap 75 can be prevented from being seen by users through the blocking cover 80 covering the avoidance gap 75, that is, it plays a role of shielding for aesthetics. Of course, it also plays a role of protecting the functional parts 60. It should be noted that different electronic components arranged on the temples 73 and the glass frame 71 can be electrically connected via a wiring harness or a flexible printed circuit board 61. For example, a main control circuit board is arranged on the glass frame 71, a battery is arranged on the temples 73, and the battery is electrically connected to the main control circuit board through the wiring harness or the flexible printed circuit board 61, thereby realizing power supply and communication. Moreover, in order to improve the heat dissipation efficiency of the head-mounted display device, the head-mounted display device may be further provided with a heat dissipation structure, such as a plurality of heat sinks, on the temples 73 or the glass frame 71, and a heat dissipation fan may be additionally provided on this basis. It will be understood that when the head-mounted display device works, the main source of heat is the main control circuit board, and the main control circuit board has an optimal operating temperature range, and if its temperature rises beyond this range, the working performance of the main control circuit board may be decreased or even damage may be occurred. Since the internal space of the temple 73 or the glass frame 71 is extremely limited, and in order to maximize the heat dissipation efficiency, the heat dissipation structure and the main control circuit board are separately arranged on the temples 73 and the glass frame 71. For example, the main control circuit board is arranged on the glass frame 71, and the heat dissipation structure is arranged on the two temples 73. In order to transfer the heat on the main control circuit board to the heat dissipation structure more quickly, a flexible thermal conductor 62 is connected between the two. Specifically, the flexible thermal conductor 62 may be a highly thermally conductive and multiply bendable part such as flexible graphite sheet, flexible graphene or thermally conductive silicone, or may be a thermally conductive material such as thermally conductive adhesive, thermally conductive silicone, etc. coated on the flexible printed circuit board 61. Since the functional parts 60 are all flexible, they can be bent more smoothly at the temple 73 connecting structure, thereby improving the user experience.

Referring to FIGS. 16 to 20, in the embodiment, optionally, the avoidance gap 75 includes a first gap 751 located at an outer side of the temple 73, and a second gap 752 located at an inner side of the temple 73, the blocking cover 80 includes an outer blocking cover 81 disposed on the first gap 751, and an inner blocking cover 82 disposed on the second gap 752, and the inner blocking cover 82 is arranged opposite to the outer blocking cover 81. It should be noted that the “outer side” and “inner side” of the temple 73 means that when the head-mounted display device is worn on the user's head, a side of the temple 73 away from the user's eyes is the outer side and a side facing the user's eyes is the inner side. In this way, the avoidance gaps 75 at the inner and outer sides of the temples 73 can be covered by the inner blocking cover 82 and the outer blocking cover 81, thereby achieving aesthetics and protective effects. Of course, in other embodiments, only an outer blocking cover or only an inner blocking cover may be provided.

Referring to FIGS. 14 and 15, in the embodiment, optionally, the inner blocking cover 82 is fixed to the base 10 by using screws, and the outer blocking cover 81 is snapped and installed on the inner blocking cover 82. As such, the connection strength between the blocking cover 80 and the base 10 can be ensured by using screws, and by disposing the screws on the inner blocking cover 82 and installing the outer blocking cover 81 on the inner blocking cover 82 by a snap-fit structure, the screws can be prevented from being exposed on the outside of the temple 73. Referring to FIGS. 18 to 20, FIGS. 18 and 19 show that the temple 73 is in a folded state, and FIG. 20 shows that the temple 73 is in a wearing state. It will be understood that when the temple 73 is in a folded state, the user can clearly see the outer blocking cover 81 but cannot see the inner blocking cover 82, that is, the screws on the inner blocking cover 82 are in a hidden state, which can improve the appearance of the products, thereby improving its market competitiveness. Of course, in other embodiments, both the inner blocking cover and outer blocking cover may be mounted on the base by using screws, or both the inner blocking cover and outer blocking cover may be mounted on the base by snap-fitting.

Referring to FIGS. 7, 8, 14, 15 and 20, in the embodiment, optionally, a screw hole 122 and a limiting hole 123 are further provided on the substrate 11 of the base 10. The inner blocking cover 82 is provided with an avoidance hole 823 corresponding to the screw hole 122 and a limiting column (not shown in the drawings) corresponding to the limiting hole 123. The limiting column is inserted into the limiting hole 123, and the screw passes through the avoidance hole 823 and is locked in the screw hole 122.

Furthermore, referring to FIGS. 16 and 17, in the embodiment, each of the two opposite side edges of the inner blocking cover 82 has a first cylindrical surfaces 821, the temple 73 slides and abuts against one of the first cylindrical surfaces 821, and the glass frame 71 slides and abuts against the other of the first cylindrical surfaces 821; each of the two opposite side edges of the outer blocking cover 81 is provided with a second cylindrical surfaces 811, the temple 73 slides and abuts against one of the second cylindrical surfaces 811, and the glass frame 71 slides and abuts against the other of the second cylindrical surfaces 811. Specifically, in the embodiment, the first cylindrical surface 821 is a cylindrical surface with an axis colinearly arranged with the axis of the adjacent rotating shaft 26, that is, the two side edges of the inner blocking cover 82 correspond one-to-one with the two rotating shafts 26 and are bent around the axis of the rotating shaft 26 close to it, is formed with a cylindrical surface. In this way, the temple 73 and the glass frame 71 mounted on the mounting bracket 20 can maintain abutment with the first cylindrical surface 821 during the rotation process, thereby maximizing the shielding and protective functions of the inner blocking cover 82. The second cylindrical surface 811 is similar to the first cylindrical surface 821 and will not be described in detail here. Of course, in other embodiments, the first cylindrical surface and the second cylindrical surface may be arranged in the form of a parabolic cylinder or an elliptical cylinder.

Furthermore, referring to FIGS. 14 to 17, in the embodiment, two opposite side edges of the inner blocking cover 82 are each provided with a first notch 822 through which the functional parts 60 passes; two opposite side edges of the outer blocking cover 81 are each provided with a second notch 812 through which the functional parts 60 passes. That is, by forming a first notch 822 on the first cylindrical surface 821 and a second notch 812 on the second cylindrical surface 811, the internal space through which the functional parts 60 passes can be increased, so that the functional parts 60 can be smoothly unfolded and bent without interference or obstruction.

Referring to FIGS. 1 and 16 to 20, the present disclosure also provides a head-mounted display device, including temples 73, a glass frame 71, and a temple 73 connecting structure described above. The specific structure of the temple 73 connecting structure refers to the above embodiments. Since the head-mounted display device adopts all the technical solutions of all the above embodiments, it has at least all the beneficial effects brought by the technical solutions of the above embodiments, which will not be repeated here. One of the mounting brackets 20 of the temple 73 connecting structure is connected to the temples 73, and the other of the mounting brackets 20 is connected to the glass frame 71.

The above are only optional embodiments of the present disclosure, and do not limit the patent scope of the present disclosure. All equivalent structural changes made by using the contents of the present description and drawings under the inventive concept of the present disclosure or direct/indirect application in other related technical fields are included in the patent protection scope of the present disclosure.

The various embodiments in this specification are described in a parallel or progressive manner, and each embodiment focuses on the differences from other embodiments, and the same or similar parts between the various embodiments may be referred to each other. As for the device disclosed in the embodiment, since it corresponds to the method disclosed in the embodiment, the description is relatively simple. For relevant parts, please refer to the description of the method.

It should be noted that relational terms such as first and second described herein are only used to distinguish one entity or operation from another entity or operation, and do not necessarily require or imply any such actual relationship or order between these entities or operations. Moreover, terms such as “comprise”, “include” or any other variation thereof are intended to encompass a non-exclusive inclusion such that a process, method, article or apparatus that includes a series of elements includes not only those elements, but also other elements not explicitly listed, or elements inherent to such a process, method, article or apparatus. Without further limitation, the element defined by the phrase “comprising a . . . ” does not preclude the presence of additional identical elements in the process, method, article or apparatus including the element.

1. A temple connecting structure applied to a head-mounted display device comprising a glass frame and two temples respectively provided at two ends of the glass frame, the temple connecting structure comprising:
a base;
mounting brackets rotatably connected to the base, wherein two mounting brackets are provided, one of the mounting brackets is connected to the glass frame, and the other of the mounting brackets is connected to the temples; and
clamping elastic members provided corresponding to each of the mounting brackets and connected between the respective mounting brackets and the base.

2. The temple connecting structure of claim 1, wherein the clamping elastic member is a torsion spring, which has a columnar spiral portion and two mounting portions respectively provided at two ends of the spiral portion,
wherein one of the mounting portions is connected to the base, and the other of the mounting portions is connected to the mounting bracket, and a gap is formed between two adjacent turns of the spiral portion,
wherein one of the base and the mounting bracket is provided with a mounting column, the torsion spring is sleeved on the mounting column, and one end of the mounting column that passes through the torsion spring is provided with a first threaded portion, and
wherein the temple connecting structure further comprises a first fastener, which is threadedly connected to the first threaded portion and abuts against the spiral portion of the torsion spring.

3. The temple connecting structure of claim 2, wherein the mounting bracket is provided with a first limiting groove at a position corresponding to the torsion spring, the first limiting groove extends along a circumference direction of the mounting column and has a first end wall and a second end wall opposite to each other, and the mounting portion of the torsion spring slides in the first limiting groove,
wherein the mounting bracket has a plurality of rotation positions comprising a folding position, an adaptation position and an eversion position in sequential, the mounting portion is separated from the first end wall at between the folding position and the adaptation position, the mounting portion abuts against the first end wall at the eversion position, and the torsion spring generates an elastic force, so that the mounting bracket has a tendency to rotate toward the adaptation position.

4. The temple connecting structure of claim 3, wherein at the adaptation position, an angle between the two mounting brackets is an obtuse angle and the two temples are positioned close to each other.

5. The temple connecting structure of claim 1, wherein the temple connecting structure further comprises a damping member mounted on the base and configured to generate a damping effect on a rotation of the mounting bracket relative to the base.

6. The temple connecting structure of claim 5, wherein one of the base and the mounting bracket is provided with an axle hole, the other of the base and the mounting bracket is supported against a hole edge of the axle hole and is provided with a rotating shaft corresponding to the axle hole, the rotating shaft is rotatably connected to the axle hole, and the damping member is configured to make the mounting bracket and the base have a tendency to push against each other.

7. The temple connecting structure of claim 6, wherein the damping member has elasticity and an annular shape, the rotating shaft is provided with a second threaded portion, the second threaded portion passes through the axle hole and the damping member and is threadedly connected to a second fastener, and the damping member is interposed between the second fastener and the other hole edge of the axle hole.

8. The temple connecting structure of claim 7, wherein the damping element is a disc spring.

9. The temple connecting structure of claim 1, wherein the base is provided with two first rotating portions, axes of the two first rotating portions are parallel and spaced apart from each other, one of the first rotating portions is rotatably connected to one of the mounting brackets, and the other of the first rotating portions is rotatably connected to the other of the mounting brackets.

10. The temple connecting structure of claim 9, wherein the first rotating portion is an axle hole, the mounting bracket is provided with a rotating shaft corresponding to the axle hole, and a transmission structure is further provided between the rotating shafts on the two mounting brackets, and
wherein the transmission structure is configured to transmit rotational motions of the two mounting brackets to each other.

11. The temple connecting structure of claim 10, wherein the transmission structure comprises a first tooth portion and a second tooth portion meshing with each other, the first tooth portion is provided on a periphery of one of the rotating shafts, and the second tooth portion is provided on a periphery of the other of the rotating shafts.

12. The temple connecting structure of claim 1, wherein the head-mounted display device further comprises a functional part comprising at least one of a wiring harness, a flexible printed circuit board and a flexible thermal conductor,
wherein a first chamber is provided in the glass frame, a second chamber is provided in the temple, and the first chamber is in communication with the second chamber through which the functional part passes,
wherein an avoidance gap is formed between a chamber opening of the first chamber and a chamber opening of the second chamber, and the avoidance gap is located between the two mounting brackets, and
wherein the temple connecting structure further comprises a blocking cover disposed on the avoidance gap.

13. The temple connecting structure of claim 12, wherein the avoidance gap comprises a first gap located at an outer side of the temple and a second gap located at an inner side of the temple, the blocking cover comprises an outer blocking cover disposed on the first gap and an inner blocking cover disposed on the second gap, and the inner blocking cover is disposed opposite to the outer blocking cover.

14. The temple connecting structure of claim 13, wherein the inner blocking cover is fixed to the base by a screw, and the outer blocking cover is snapped and installed on the inner blocking cover, and/or
each of two opposite side edges of the inner blocking cover has a first cylindrical surface, wherein the temple slides and abuts against one of the first cylindrical surfaces, and the glass frame slides and abuts against the other of the first cylindrical surfaces, and/or
each of the two opposite side edges of the inner blocking cover is provided with a first notch through which the functional part passes, and/or
each of two opposite side edges of the outer blocking cover has a second cylindrical surface, wherein the temple slides and abuts against one of the second cylindrical surfaces, and the glass frame slides and abuts against the other of the second cylindrical surfaces, and/or
each of the two opposite side edges of the outer blocking cover is provided with a second notch through which the functional part passes.

15. A head-mounted display device, comprising temples, a glass frame, and a temple connecting structure according to claim 1, wherein one of the mounting brackets of the temple connecting structure is connected to the temples, and the other of the mounting brackets is connected to the glass frame.
